(19) United States
(12) Patent Application Publication
(10) Pub. No.: US 2007/0283404 A1
(43) Pub. Date: Dec. 6, 2007

(54) METHOD AND APPARATUS FOR TRANSMITTING/RECEIVING ENCRYPTED ELECTRONIC SERVICE GUIDE IN DVB-H CBMS SYSTEM

(75) Inventors: Yiling XU, Suwon-si (KR); Jae-Yeon SONG, Seoul (KR); Kook-Heui LEE, Yonging-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/750,784

(22) Filed: May 18, 2007

Related U.S. Application Data
(60) Provisional application No. 60/801,102, filed on May 18, 2006.

(51) Int. Cl. H04N 7/173

(52) U.S. Cl. 725/118; 375/240.25; 375/E07.026

(57) ABSTRACT

Disclosed is a system and method for transmitting/receiving an encrypted Electronic Service Guide (ESG) in a mobile Digital Video Broadcasting-Handheld (DVB-H) Convergence of Broadcast and Mobile Service (CBMS) system. When a terminal performs roaming from a home network to a visited network, the terminal receives an ESG from a neighboring network and determines whether to perform user roaming or to perform service roaming according to the received ESG. In this case, the visited network provides the terminal either with an encrypted ESG and a key for the encrypted ESG, or with non-encrypted ESG through a dedicated channel, so that it is possible to provide the ESG only to specified terminals.

This application claims priority under U.S.C. §119(a) to a U.S. Provisional Application entitled “Method And Apparatus For Transmitting/Receiving Encrypted Electric Service Guide In DVB-H CBMS System” filed in the United States Patent and Trademark Office on May 18, 2006 and assigned Ser. No. 60/801,102, the contents of which are incorporated herein by reference.

### BACKGROUND OF THE INVENTION

1. Field of the Invention

The present invention relates to a mobile Digital Video Broadcasting-Handheld (DVB-H) Convergence of Broadcast and Mobile Services (CBMS) system, and more particularly to an apparatus and method for transmitting/receiving an encrypted Electronic Service Guide (ESG) in a CBMS system.

2. Description of the Related Art

FIG. 1 is a block diagram illustrating the configuration of a typical Convergence of Broadcast and Mobile Services (CBMS) system. The entities illustrated in FIG. 1 include logical entities that may or may not be physically discriminated, in which these logical entities can be combined into one or more physical entities. In addition, only the interfaces relating to the gist of the present invention are illustrated in FIG. 1

The system illustrated in FIG. 1 is for the Digital Video Broadcasting-Convergence of Broadcast quad Mobile Services (DVB-CBMS), which is one of the standard structures for mobile broadcast terminals. Although the notification broadcasting structure is described by exemplifying the DVB-CBMS for the convenience of description other mobile broadcast systems having a notification message function operate in similar ways.

Referring to FIG. 1, the Content Creation (CC) unit 110 is a provider of broadcasting services which include conventional voice/image broadcasting services, file (music file or data file) download services, etc. When there is a problem or change in supply of the broadcasting services, the CC unit 110 notifies the change to a notification event generator within a broadcasting Service Application (SA) unit 120.

The SA unit 120 receives content data of the broadcasting service from the CC unit 110, generates broadcasting service data by processing the content data into a type proper for the broadcast network (e.g., streaming audio/video or movie download, etc.), generates standardized metadata necessary for an Electronic Service Guide (ESG), and generates charging information according to users. In addition, the SA unit 120 receives notification of a change in the broadcasting service from the CC unit 110, transfers a notification event to a notification message generator disposed within a Service Management (SM) unit 130, and provides service guide property information used in generating the notification message to the notification message generator.

The SM unit 130 determines a transmission schedule for the broadcasting service provided from the SA unit 120 and generates a service guide. The SM unit 130 is connected to a broadcast network 140 for providing the broadcasting service and an interactive network 150 for supporting, interactive communication.

The SM unit 130 manages subscriber information for receiving the broadcasting service, service provision information (such as information about if a subscriber has purchased related contents), and device information about terminals receiving the broadcasting service. In addition, the SM unit 130 transmits user charging information to the SA unit 120 and provides the subscriber information, the service provision information and the device information to the broadcast network 140 and the interactive network 150.

The broadcast network 140 is a network for transmitting a broadcasting service, as an example of which the DVB-H is described in this document.

The interactive network 150 transmits a broadcasting service one to one or interactively exchanges control information and additional information in relation to reception of the broadcasting service. For example, the interactive network 150 may be a conventional cellular network such as the 3GPP Wideband Code Division Multiple Access (WCDMA) network.

A terminal 160 can receive a broadcasting service and may be connected with a cellular network according to its capability. In the following description, it is assumed that the terminal 160 can be connected with a cellular network.

Interfaces between blocks of the mobile broadcast system will now be described.

CBMS-x refers to an interface within a range of an Internet Protocol (IP) datacast standard through the DVB-H, and X-x refers to an interface out of the range of the IP datacast standard through the DVB-H. In detail, CBMS-7 interface is used for transmission from the SA unit 120 to the SM unit 130, and CBMS-3 interface is used when a message is directly transmitted from the SM unit 130 to the terminal 160 through the broadcast network 140 and a broadcast channel. CBMS-4 interface is used when a message transmitted from the SM unit 130 is directly provided to the terminal 160 either through a dedicated channel for the terminal 160 via the interactive network 150 or through a broadcast channel provided by the interactive network 150. CBMS-6 interface is an interface between the SM unit 130 and the broadcast network 140, and is used for the SM unit 130 either to set a transmission path to be used in the broadcast network 140 or to receive event information occurring in the broadcast network 140. CBMS-1 interface is used to carry a control signal of the broadcast network, which is transferred to the terminal. In the DVB-H, a control signal channel called Program Specific Information/Service Information (PSI/SI) corresponds to CBMS-1. X-3 interface is an interface for setting a transmission path to be used between the SM unit 130 and the interactive network 150. X-2 interface is an interface for setting a transmission path to be used between the terminal 160 and the interactive network 150. X-1 interface is an interface for setting a transmission path to be used between the CC unit 110 and the SA unit 120.

It is assumed in a CBMS system that one SM instance is disposed on one IP platform. Therefore, a terminal existing within one IP platform implies that it is under the control of one service, while a terminal existing within another IP platform implies that it is under the control of another service.

FIG. 2 is a block diagram illustrating the definitions of roaming and handover in a CBMS system.

The handover is caused when a terminal moves within the coverage of the home IP platform (SM), and the roaming is caused when a terminal moves from the coverage of the home IP platform into the coverage of a different IP platform. Especially, in the CBMS system, roaming means that a user accesses an Internet Protocol DataCasting (IPDC) service of an IP platform, other than the home IP platform. In the CBMS system, roaming is classified into service roaming and user roaming according to if a selected service can be used in a new IP platform.

In the case of service roaming, a service selected in an original IP platform can be received in a different IP platform, in which the selected service may be received from a transmission stream provided by a different IP platform in a DVB-H network. Also, the selected service can be received through an interactive channel. In the case of user roaming, a user can access an IPDC service provided by an IP platform, other than a home IP platform.

According to ESG standardization Phase I. ESGs are provided free of charge. Therefore, ESGs can be viewed by terminals, regardless of networks providing the ESGs. Also, when a terminal moves into the coverage of a neighboring network, the user of the terminal can see an ESG provided by the neighboring network and select a desired service. This is a typical roaming procedure. However, there is a need for providing an ESG not to all users but to specified users only, Such as users over eighteen years old.

### SUMMARY OF THE INVENTION

Accordingly, the present invention has been made to solve the above-mentioned problems occurring in the prior art, and the present invention provides a method and apparatus for transmitting/receiving an encrypted ESG in a Digital Video Broadcasting-Handheld (DVB-H) Convergence of Broadcast and Mobile Services (CBMS) system.

In addition, the present invention provides a method and apparatus for roaming in a DVB-H CBMS system in which all encrypted ESG is provided.

In accordance with all aspect of the present invention, there is provided a method for receiving an encrypted Electronic Service Guide (ESG) from a neighboring network, by a terminal located in a home network, in a mobile Digital Video Broadcasting-Handheld (DVB-H) Convergence of Broadcast and Mobile Services (CBMS) system, which includes transmitting, by the terminal, which determines that it is necessary to roam into the neighboring network, a request message of an ESG to the neighboring network through an interactive network: receiving, by the terminal, a key to decode the ESG which has been encrypted from the neighboring network through the interactive network; receiving, by the terminal, the encrypted ESG from the neighboring network through a broadcast network, and decoding the encrypted ESG by means of the key: and determining, by the terminal, a roaming procedure for the roaming based on the decoded ESG, and performing the determined roaming procedure.

In accordance with another aspect of the present invention, there is provided a method for providing an encrypted Electronic Service Guide (ESG) to a terminal, which is located in a neighboring network, in a mobile Digital Video Broadcasting-Handheld (DVB-H) Convergence of Broadcast and Mobile Services (CBMS) system, which includes receiving, by the neighboring network, a request message of an ESG for a roaming user from the terminal through an interactive network; providing, by the neighboring network, a key to decode the ESG which has been encrypted to the terminal through the interactive network, and transmitting the encrypted ESG through a broadcast network: and performing, by the neighboring network, a roaming procedure with the terminal according to a roaming proposal message transmitted from the terminal which has received the encrypted ESG.

In accordance with another aspect of the present invention, there is provided a method for receiving an encrypted Electronic Service Guide (ESG) from a network, by a terminal, in a mobile Digital Video Broadcasting-Handheld (DVB-H) Convergence of Broadcasting and Mobile Service (CBMS) system, which includes transmitting, by the terminal, a request message of an ESG to the network through an interactive network; receiving, by the terminal, a key to decode the ESG which has been encrypted from the network through the interactive network; receiving, by the terminal, the encrypted ESG from the network through a broadcast network, and decoding the encrypted ESG by means of the key; and selecting, by the terminal, a desired service based on the decoded ESG, and requesting the network to provide the selected service.

In accordance with another aspect of the present invention, there is provided a method for providing an encrypted Electronic Service Guide (ESG) to a terminal in a mobile Digital Video Broadcasting-Handheld (DVB-H) Convergence of Broadcast and Mobile Services (CBMS) system, which includes receiving, by a network, a request message of an ESG from the terminal through an interactive network; providing, by the network, a key to decode the encrypted ESG to the terminal through the interactive network, and transmitting the encrypted ESG through a broadcast network; and transmitting, by the network, a service requested by the terminal which has received the ESG, to the terminal.

In accordance with another aspect of the present invention, there is provided a network apparatus for providing all encrypted Electronic Service Guide (ESG) to a terminal in a mobile Digital Video Broadcasting-Handheld (DVB-H) Convergence of Broadcast and Mobile Services (CBMS) system, the network apparatus including a SA unit for collecting contents from sources and related metadata in order to provide applications for a specific service; an ESG provider for generating the ESG for a broadcasting service from the metadata collected by the SA unit; and a mobility management/control module for managing roaming of the terminal into a neighboring network, wherein the mobility management/control module provides the terminal with a key for decoding the ESG, which has been encrypted, and the encrypted ESG through an interactive network, when the terminal requests the ESG.

In accordance with another aspect of the present invention, there is provided a terminal for receiving an encrypted Electronic Service Guide (ESG) from a network in a mobile Digital Video Broadcasting-Handheld (DVB-H) Convergence of Broadcast and Mobile Services (CBMS) system, the terminal including a broadcast receiver for receiving a broadcasting service or signal from a broadcast network: an interactive adaptor for receiving an interactive service or signal from an interactive network: and a mobility management/control module for managing roaming into a neighboring network, wherein the mobility management/control module receives the encrypted ESG of the broadcasting service provided by the network and a key for encoding the encrypted ESG through the interactive adaptor, and requests the network to provide a desired service by making reference to an ESG which has been decoded by the key.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the configuration of a typical Convergence of Broadcast and Mobile Services (CBMS) system:

FIG. 2 is a block diagram illustrating the definitions of roaming and handover in a CBMS system;

FIG. 3 is a flowchart illustrating the operation of a terminal according to an exemplary embodiment of the present invention;

FIG. 4 is a flowchart illustrating the operation of a terminal according to another exemplary embodiment of the present invention;

FIG. 5 is a flowchart illustrating the operation of a visited network according to an exemplary embodiment of the present invention;

FIG. 6 is a flowchart illustrating the operation of a visited network according to another exemplary embodiment of the present invention;

FIGS. 7A to 7C are views illustrating message flows for roaming with encrypted ESG according to an exemplary embodiment of the present invention;

FIG. 8 is a block diagram illustrating the configuration of a network according to an exemplary embodiment of the present invention; and

FIG. 9 is a block diagram illustrating the configuration of a terminal according to an exemplary embodiment of the present invention.

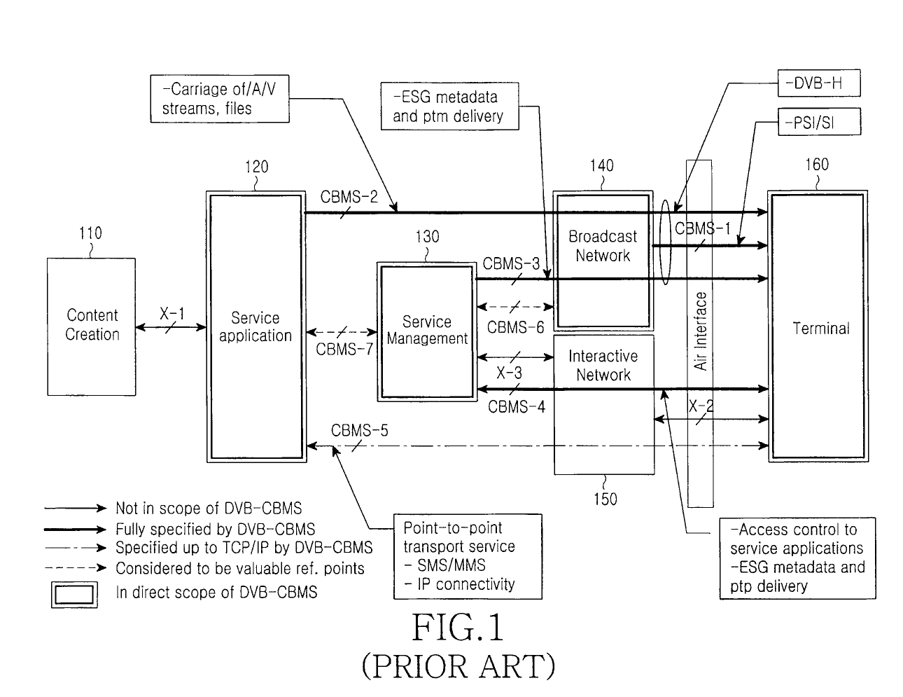

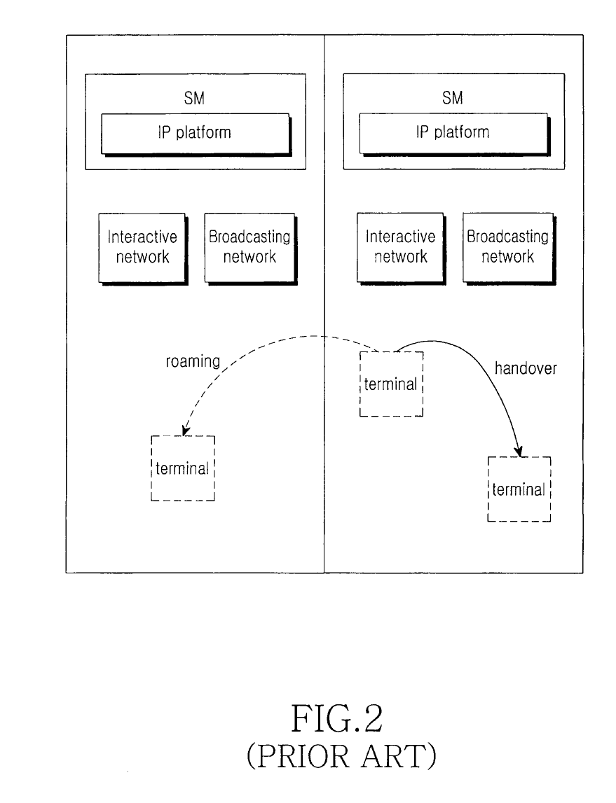

### DETAILED DESCRIPTION OF EXEMPLARY EMBODIMENTS

Hereinafter, exemplary embodiments of the present invention will be described with reference to the accompanying drawings. It is to be noted that the same elements are indicated with the same reference numerals throughout the drawings. In the following description, a detailed description of known functions and configurations incorporated herein will be omitted when it may obscure the subject matter of the present invention. In addition, the terminology used in the description is defined in consideration of the function of corresponding components used in the present invention and may be varied according to users. operator's intention, or practices. Accordingly, the definition must be interpreted based oil the overall content disclosed in the description.

According to ESG standardization Phase I, ESGs are provided free of charge. Therefore. ESGs can be viewed by terminals, regardless of which networks provide the ESGs. Also, when a terminal moves into a coverage area of a neighboring network, the user of the terminal can see an ESG provided by the neighboring network and select a desired service. This is a typical roaming procedure. However, it is assumed that an encrypted ESG will be introduced in Phase II. Encrypting an ESG implies that the ESG is not provided free of charge, and that only some specified users (e.g. users over eighteen years old) can use the ESG.

In such a scenario, since a terminal cannot recognize an encrypted ESG provided in a neighboring network, the user of the terminal cannot see which service is provided in the neighboring network. Therefore, in this case, a specific roaming procedure is required.

Since it is assumed that an encrypted ESG will be introduced in Phase II, as described above, the present invention proposes a detailed procedure, a message flow and a message format, which are required when a terminal roams into a neighboring network providing an encrypted ESG.

The roaming procedure of a terminal according to the present invention is classified depending on whether a visited network will transmit a key for an encrypted ESG (hereinafter, a “Visited ESG”) provided by the visited network to terminals or the visited network is to transmit a non-encrypted Visited ESG to the terminal. The non-encrypted Visited ESG is provided only to pre-specified terminals through a dedicated channel.

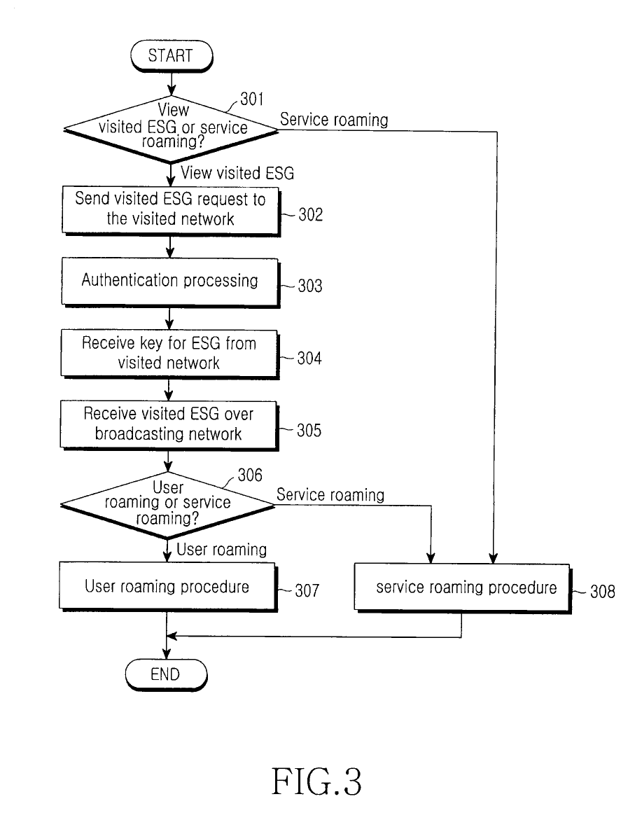

FIG. 3 is a flowchart illustrating the operation of a terminal when a visited network provides an encrypted Visited ESG to the terminal according to an exemplary embodiment of the present invention.

A terminal, which determines that a roaming process is required, selects whether to first recognize a Visited ESG or to directly start service roaming, in step 301. When having selected the service roaming, the terminal starts a service roaming procedure in step 308. When having selected to first recognize a Visited ESG the terminal transmits a Visited ESG request to the visited network in step 302. Next, the terminal performs authentication with the visited network in step 303, and receives a key (i.e. key for ESG) to decode an encrypted Visited ESG in step 304. Then, the terminal receives the encrypted Visited ESG through a broadcast network in step 305. Accordingly, the terminal can recognize which service is provided in the visited network by decoding the received Visited ESG by means of the received key, so that the terminal can determine whether to start a user roaming procedure or to start a service roaming procedure, in step 306. Then, according to the result of the determination, the terminal performs either the user roaming procedure, in step 307, or the service roaming procedure, in step 308.

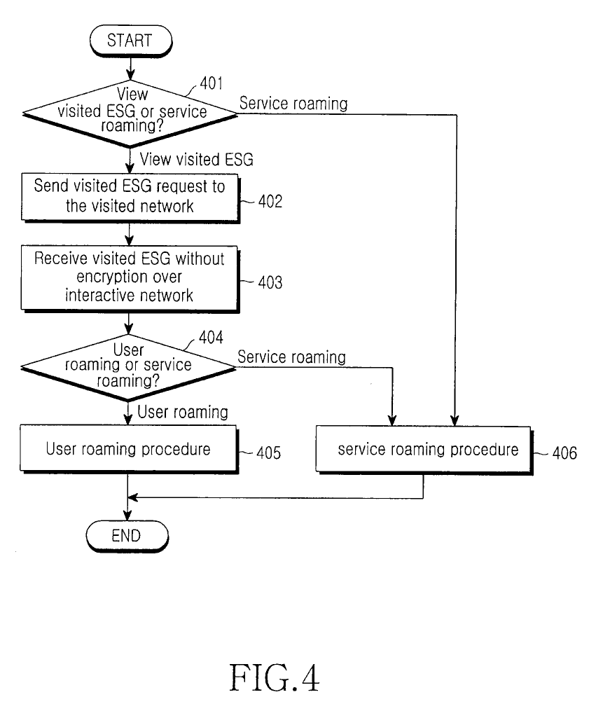

FIG. 4 is a flowchart illustrating the operation of a terminal when a visited network provides a non-encrypted ESG to the terminal according to an exemplary embodiment of the present invention.

A terminal, which determines that a roaming process is required, selects whether to first recognize a Visited ESG or to directly start service roaming, in step 401. When having selected the service roaming, the terminal starts a service roaming procedure in step 406. Upon selecting to first recognize a Visited ESG, the terminal transmits a Visited ESG request to the visited network in step 402. In step 403, the terminal receives a non-encrypted Visited ESG (i.e., Visited ESG without encryption) over an interactive network. Then, the terminal can recognize which service is provided in the visited network through the received Visited ESG, so that the terminal can determine whether to start a user roaming procedure or to start a service roaming procedure, in step 404. Next, according to a result of the determination, the terminal performs either the user roaming procedure, in step 405, or the service roaming procedure, in step 406.

The operation of a visited network will now be described.

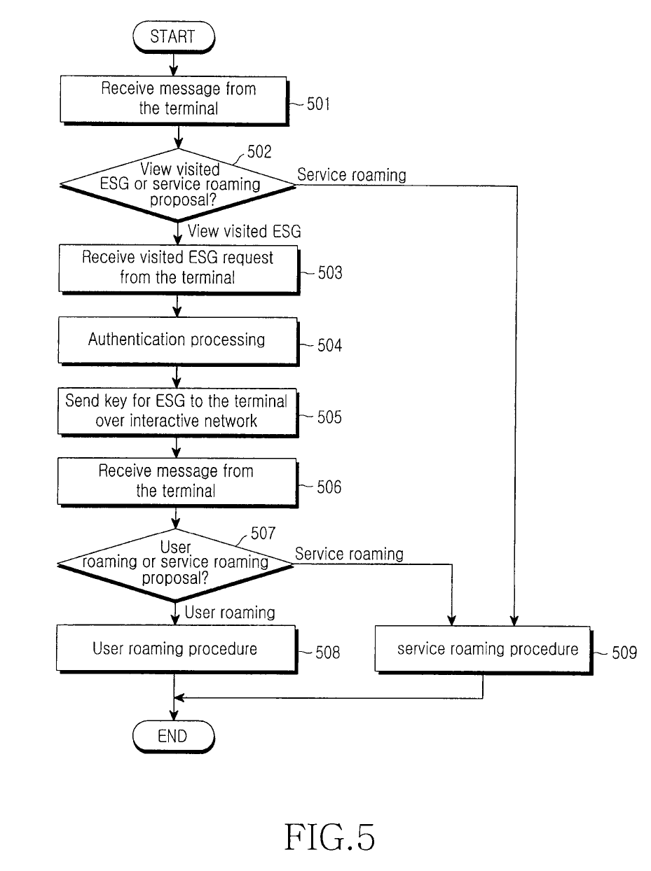

FIG. 5 is a flowchart illustrating the operation of a visited network when the visited network provides an encrypted Visited ESG to the terminal according to an exemplary embodiment of the present invention.

When receiving a Visited ESG request from a terminal in step 501, the visited network determines whether the terminal is to receive a Visited ESG or to perform service roaming, in step 502. When determining that the terminal is to perform service roaming, the visited network performs a service roaming procedure with the terminal in step 509. In contrast, when determining that the terminal is to receive a Visited ESG, the visited network performs an authentication procedure with a home network of the terminal in step 504. When having completed the authentication procedure, the visited network transmits a key (i.e. key for ESG) to decode an encrypted Visited ESG to the terminal in step 505. Next, when receiving a roaming request message from the terminal in step 506, the visited network selects either a user roaming procedure or a service roaming procedure according to the request of the terminal in step 507, and then performs the user roaming procedure, in step 508, or the service roaming procedure, in step 509, according to the selected procedure.

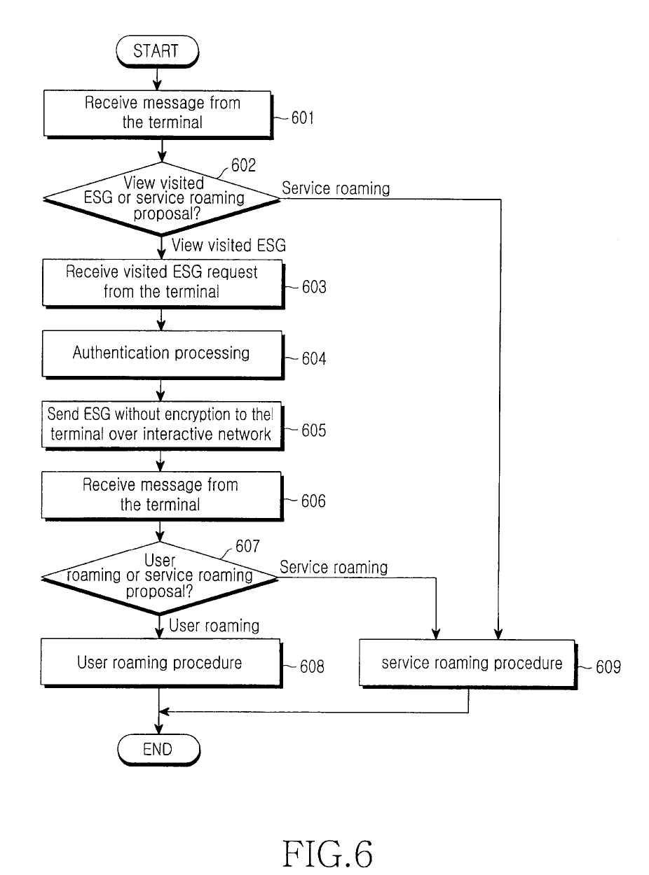

FIG. 6 is a flowchart illustrating the operation of a visited network when the visited network provides a non-encrypted Visited ESG to the terminal according to an exemplary embodiment of the present invention.

When receiving a Visited ESG request from a terminal in step 601, the visited network determines whether the terminal is to receive a Visited ESG or to perform service roaming, in step 602. When determining that the terminal is to perform service roaming, the visited network performs a service roaming procedure with the terminal in step 609. In contrast, when determining that the terminal is to receive a Visited ESG, the visited network performs an authentication procedure with a home network of the terminal in step 604. Through the authentication procedure, the visited network determines if the terminal corresponds to a terminal that can receive a non-encrypted ESG. When having completed the authentication procedure, the visited network transmits a non-encrypted Visited ESG to the terminal over an interactive network in step 605. Next, when receiving a roaming request message from the terminal in step 606, the visited network selects either a user roaming procedure or a service roaming procedure according to the request of the terminal in step 607, and then performs the user roaming procedure, in step 608, or the service roaming procedure, step 609, according to the selected procedure.

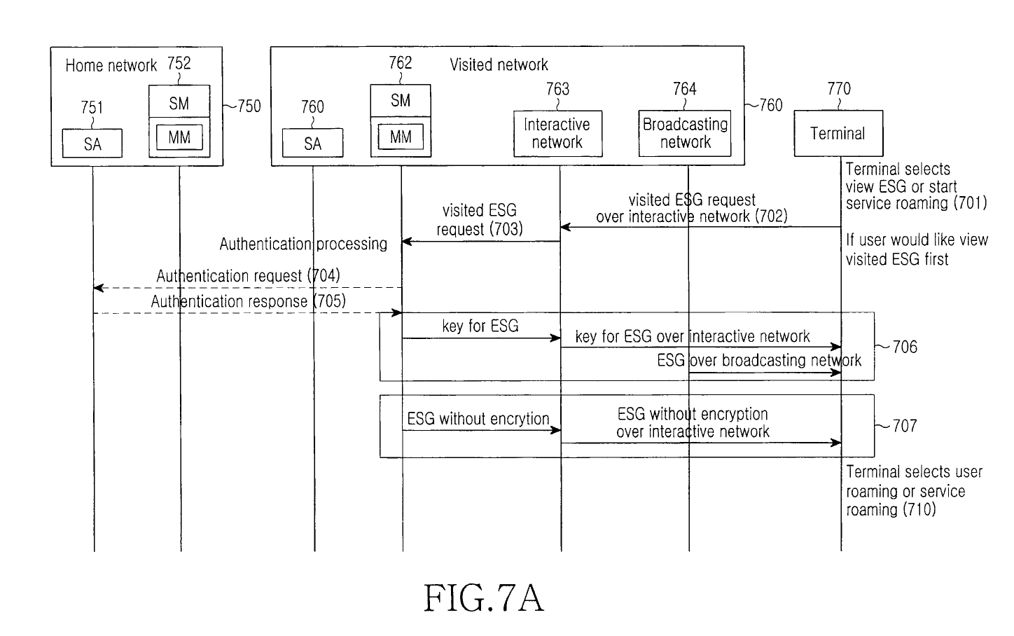

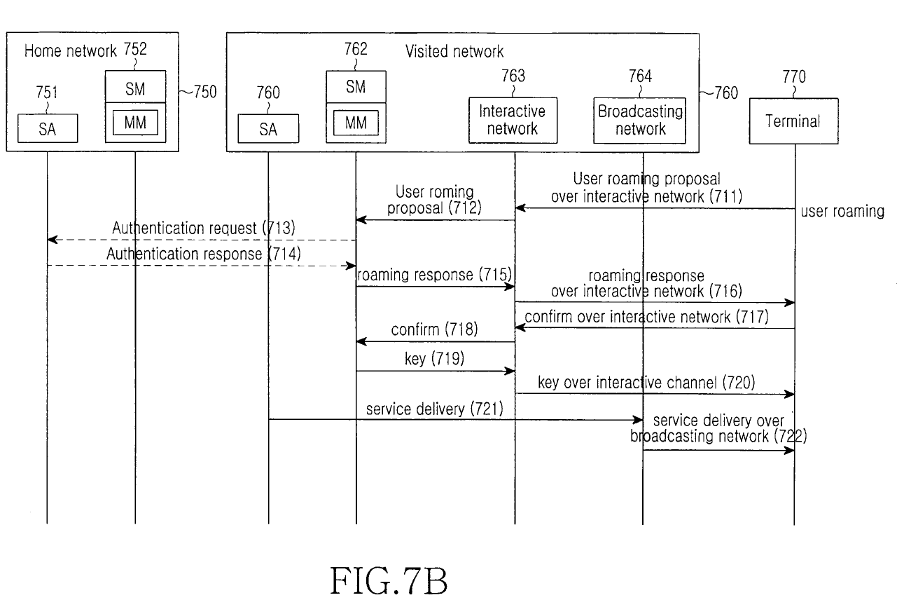

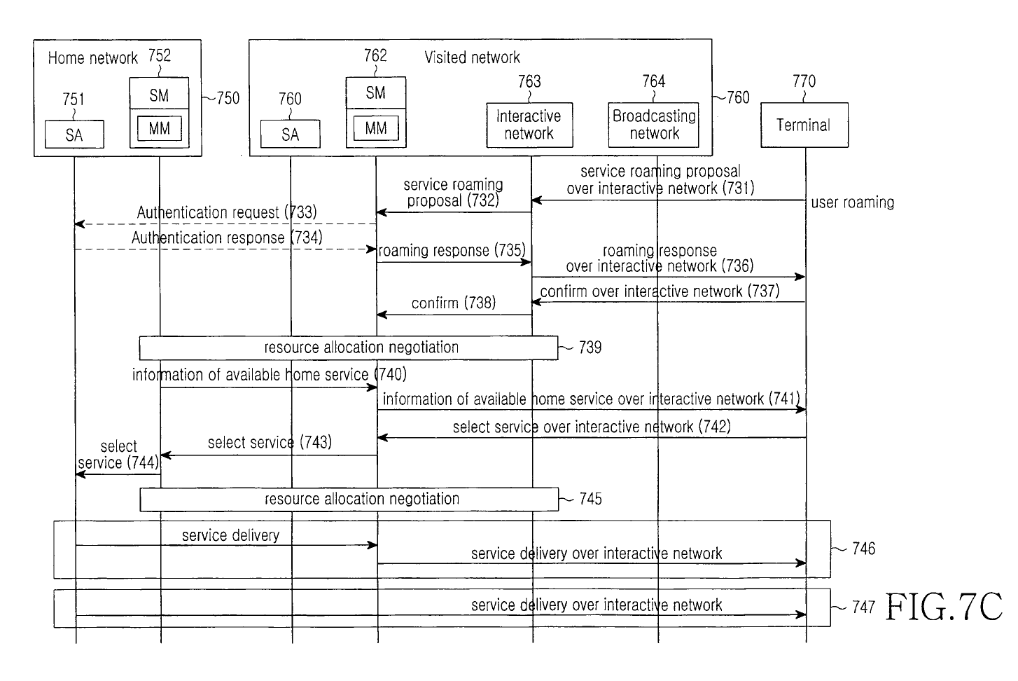

FIGS. 7A to 7C are views illustrating message flows of a roaming procedure according to an exemplary embodiment of the present invention.

As shown in FIG. 7A, a terminal 770, which determines that roaming is required, selects whether to receive a Visited ESG or to perform service roaming, in step 701. When having determined to receive a Visited ESG, the terminal 770 transmits a Visited ESG request message to a visited network 760 over an interactive network 763 in step 702. The interactive network 763 of the visited network 760 transmits the Visited ESG request message, which has been received loom the terminal 770, to a Mobility Management/control module (MM) included in a SM unit 762, in step 703. The mobility management/control module performs an authentication procedure with a SM unit 752 of a home network 750 in steps 704 and 705. If the visited network 760 provides an encrypted Visited ESG, after the authentication procedure has been completed, the SM unit 762 of the visited network 760 transmits a key (i.e. key for ESG) to decode the encrypted Visited ESG to the terminal 770 over the interactive network 763, and a broadcast network 764 transmits the encrypted Visited ESG to the terminal 770, in step 706. In contrast, if the visited network 760 provides a non-encrypted Visited ESG after the authentication procedure has been completed, the SM unit 762 of the visited network 760 transmits the non-encrypted Visited ESG to the terminal 770 over the interactive network 763, in step 707. The terminal 770 recognizes the Visited ESG received from the visited network 760, and determines whether to perform user roaming or to perform service roaming, in step 710.

As shown in FIG. 7B, upon determining to perform user roaming, the terminal 770 transmits a user roaming proposal over the interactive network 763, in step 711, and then the interactive network 763 forwards the user roaming proposal to the SM unit 762, in step 712. Then, the SM unit 762 performs authentication with the SM unit 752 of the home network 750 in steps 713 and 714, transmits a roaming response message to the terminal 770 over the interactive network 763 in steps 715 and 716, and then receives a confirmation message of the transmitted message in steps 717 and 718. Also, the SM unit 762 transmits a key to the terminal 770 over the interactive network 763 in steps 719 and 720, and provides a service to the terminal 770 through the broadcast network 764 in steps 721 and 722.

Meanwhile, as shown in FIG. 7C, upon determining to perform service roaming, the terminal 770 transmits a service roaming proposal over the interactive network 763 in step 731, and then the interactive network 763 forwards the service roaming proposal to the SM unit 762 in step 732. Then, the SM unit 762 performs authentication with the SM unit 752 of the home network 750 in steps 733 and 734, transmits a roaming response message to the terminal 770 over the interactive network 763 in steps 735 and 736, and then receives a confirmation message of the transmitted message in steps 737 and 738. Also, the visited network 760 performs a resource allocation negotiation with the home network 750 in step 739, and the home network 750 transmits information about available home services to the visited network 760 in step 740. The SM unit 762 of the visited network 760 transmits the information about available home services, which has been received from the home network 750, to the terminal 770 over the interactive network 763 in step 741. The terminal 770 selects a desired service based on the received information about available home services and requests the selected service to the visited network 760 in step 742. The SM unit 762 of the visited network 760 forwards the service request, which has been received from the terminal 770 over the interactive network 763, to the home network 750, in steps 743 and 744, and then the home network 750 and visited network 760 perform a resource allocation negotiation for a home service requested by the terminal 770, in step 745. When the negotiation has been completed, the SM unit 762 of the visited network 760 receives and forwards a corresponding service from the home network 750 to the terminal 770 over the interactive network 763. Otherwise, the visited network 760 may directly forward the service, which is provided from the home network 750, to the terminal 770 over the interactive network 763, as shown in step 746, without passing through the SM unit 762.

Hereinafter, the format of a message for a roaming procedure according to an exemplary embodiment of the present invention, which is illustrated in FIGS. 7A to 7C, will be described.

The Visited ESG request message transmitted in step 703 includes a Visited ESG request ID, a user ID and a home network ID. In addition, selectively, the Visited ESG request message may further include a roaming key. Each component included in the Visited ESG request message is defined as Table 1 below.

TABLE 1

| Name | Description |
|---|---|
| Visited ESG request ID | Identifier for Visited ESG request message |
| User ID | User identifier |
| Home network ID | Home network identifier |
| Roaming key (option) | May be used for roaming request in visited |
| | network according to agreement between home |
| | network and visited network |

The key for ESG in step 706 includes a key for ESG ID, a visited network ID and a key. In addition, selectively, the key for ESG may further include charging and rights. Each component included in the key for ESG is defined as Table 2 below.

TABLE 2

| Name | Description |
|---|---|
| Key for ESG ID | Identifier of key for ESG message |
| Visited network ID | Identifier of visited network |
| Key | Key to decode encrypted Visited ESG |
| Charging (option) | Based on charging information |
| Rights (option) | Information about method of acquiring |
| | the right of service use |

The non-encrypted Visited ESG (i.e., ESG without encryption) transmitted in step 707 includes an ESG-without-encryption ID, a visited network ID, and an ESG without encryption. In addition, selectively, the non-encrypted Visited ESG may further include charging and rights. Each component included in the key for ESG is defined as Table 3 below.

TABLE 3

| Name | Description |
|---|---|
| ESG-without-encryption ID | Identifier of ESG without encrypted |
| | message |
| Visited network ID | Identifier of visited network |
| ESG without encryption | Visited ESG which terminal can |
| | recognize without decryption |
| Charging (option) | Based on charging information |
| Rights (option) | Information about method of acquiring |
| | the right of service use |

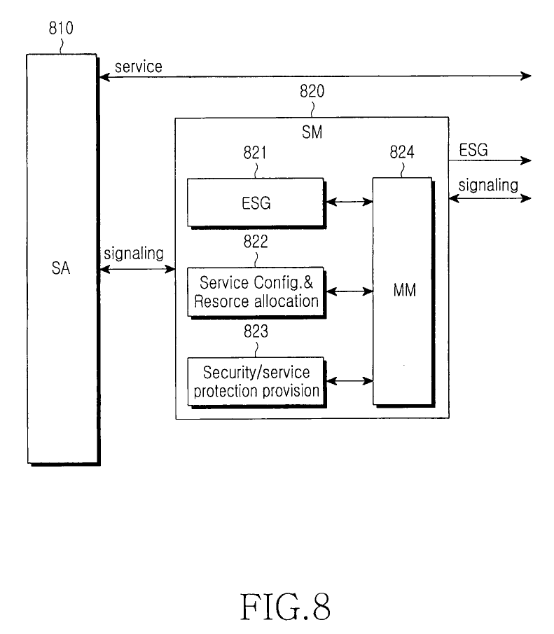

FIG. 8 is a block diagram illustrating the configuration of a network according to an exemplary embodiment of the present invention.

A SA unit 810 collects contents from multiple sources and related metadata in order to provide specific SAs, provides head-end application logic, provides contents encoded in a format which the terminal can understand through streaming or file carousel transfer, and generates metadata to be used in the ESG. Service application units 810 may exist for each application that is provided in an IP datacast.

A SM unit 820 includes lower entities, including an ESG provider 821, a service configuration/resource allocation unit 822, a security/service protection provider 823, and a mobility management/control module 824. The mobility management/control module 824 can support the roaming process through communication with the other three entities 821 to 823. Further, the mobility management/control module 824 transmits/receives roaming proposals and responses, communicates with other entities and lower entities so as to support the roaming process, and communicates with a mobility management/control module of another network in order to exchange information. The service configuration/resource allocation unit 822 registers SAs competing with each other in order to obtain a bandwidth of a broadcasting bearer, allocates services to a bandwidth and point related to the type of the broadcast network, and schedules the services over time. The ESG provider 821 collects ESG (metadata information) fragments from the SAs 810. The security/service protection provider 823 manages user access to the SAs 810.

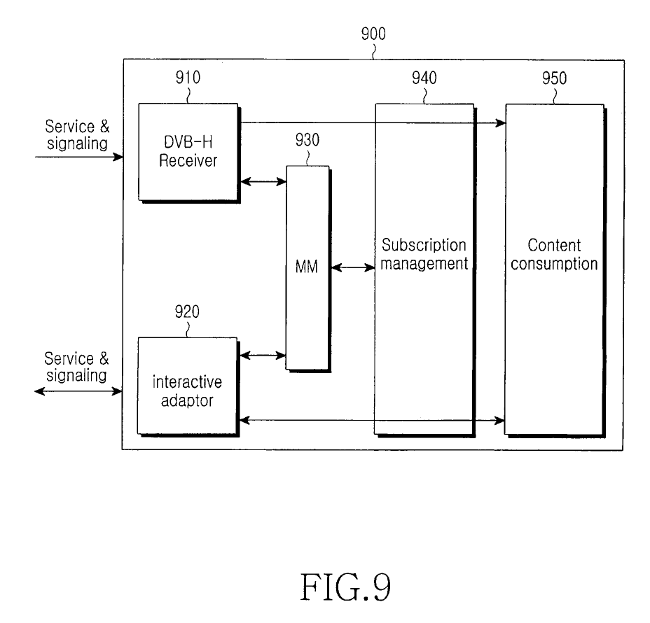

FIG. 9 is a block diagram illustrating the configuration of a terminal according to an exemplary embodiment of the present invention.

A DVB-H receiver 910 receives service or signaling through a broadcast network. An interactive adaptor 920 transmits/receives service or signaling through an interactive network. A mobility management/control module 930 takes charge of a roaming process. A subscription management unit 940 manages obtainment of the right, continuously traces the right obtained by the terminal, and manages decoding of service contents. A content consumption unit 950 consumes contents.

Although the present invention has been described in a case where a terminal roams to a neighboring network, the present invention is not limited thereto, and can likewise be applied to a case where an encrypted ESG is provided to a terminal in a home network to which the terminal belongs. In this case, an authentication procedure between the home network and a visited network is not required.

According to the present invention, when a terminal performs roaming from a home network to a visited network, the terminal receives an ESG from a neighboring network and determines whether to perform user roaming or to perform service roaming through the received ESG. Since the visited network provides the terminal with an encrypted ESG and a key for the encrypted ESG the terminal can check if the visited network provides a service desired by the terminal by decoding the encrypted ESG. In addition, the visited network may provide an ESG only to specified pre terminals through a dedicated channel.

while the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for receiving an encrypted Electronic Service Guide (ESG) from a neighboring network, by a terminal located in a home network, in a mobile Digital Video Broadcasting-Handheld (DVB-H) Convergence of Broadcasting and Mobile Service (CBMS) system, the method comprising the steps of:
transmitting a, by the terminal which determines that it is necessary to roam into the neighboring network, a request message of an ESG to the neighboring network through an interactive network;
receiving, by the terminal, a key to decode the ESG which has been encrypted from the neighboring network through the interactive network;
receiving, by the terminal, the encrypted ESG from the neighboring network through a broadcast network, and decoding the encrypted ESG by means of the key; and
determining, by the terminal, a roaming procedure for roaming, based on the decoded ESG, and performing the determined roaming procedure.

2. The method as claimed in claim 1, wherein, in the step of determining the roaming procedure, when it is determined, based on the decoded ESG, that the neighboring network provides a service desired by the terminal the terminal performs a service roaming procedure of receiving the desired service from the neighboring network through the interactive network; and
when it is determined, based on the decoded ESG, that the neighboring network does not provide the service desired by the terminal, the terminal performs a user roaming procedure of receiving a service provided by the neighboring network.

3. The method as claimed in claim 1, wherein the request message includes an identifier of the terminal, and an identifier of the home network.

4. The method as claimed in claim 1, wherein the key for decoding is transmitted together with an identifier of the neighboring network.

5. The method as claimed in claim 1, wherein the key to decode the ESG is received through a dedicated channel of the interactive network.

6. A method for providing an encrypted Electronic Service Guide (ESG) to a terminal, which is located in a neighboring network, in a mobile Digital Video Broadcasting-Handheld (DVB-H) Convergence of Broadcast and Mobile Services (CBMS) system, the method comprising the steps of:
receiving, by the neighboring network, a request message of an ESG for a roaming user from the terminal through an interactive network;
providing, by the neighboring network, a key to decode the ESG which has been encrypted to the terminal through the interactive network and transmitting the encrypted ESG through a broadcast network; and
performing, by the neighboring network, a roaming procedure with the terminal according to a roaming proposal message transmitted from the terminal, which has received the encrypted ESG.

7. The method as claimed in claim 6, wherein, in the step of performing a roaming procedure, the neighboring network performs one roaming procedure of a user roaming procedure of providing a service provided by the neighboring network to the terminal, and a service roaming procedure of providing a service desired by the terminal from the neighboring network to the terminal through the interactive network, according, to a selection of the terminal.

8. The method as claimed in claim 7, wherein the terminal selects to perform the service roaming procedure when the desired service is included in the ESG and the terminal selects to perform the user roaming procedure when the desired service is not included in the ESG.

9. The method as claimed in claim 6, wherein the request message includes an identifier of the terminal, and an identifier of a home network in which the terminal is currently located.

10. The method as claimed in claim 6, wherein the key for decoding the ESG is transmitted through a dedicated channel of the interactive network.

11. A method for receiving an encrypted Electronic Service Guide (ESG) from a network, by a terminal, in a mobile Digital Video Broadcasting-Handheld (DVB-H) Convergence of Broadcasting and Mobile Service (CBMS) system, the method comprising the steps of:
transmitting, by the terminal, a request message of an ESG to the network through an interactive network;
receiving, by the terminal, a key to decode the ESG which has been encrypted from the network through the interactive networks;
receiving, by the terminal, the encrypted ESG from the network through a broadcast network, and decoding the encrypted ESG by means of the key; and
selecting, by the terminal, a desired service based on the decoded ESC and requesting the network to provide the selected service.

12. The method as claimed in claim 11, wherein the key for decoding the ESG is received through a dedicated channel of the interactive network.

13. A method for providing an encrypted Electronic Service Guide (ESG) to a terminal in a mobile Digital Video Broadcasting-Handheld (DVB-H) Convergence of Broadcast and Mobile Services (CBMS) system, the method comprising the steps of:
receiving, by a network, a request message of an ESG from the terminal through an interactive network;
providing, by the network, a key to decode the encrypted ESG to the terminal through the interactive network, and transmitting the encrypted ESG through a broadcast network; and
transmitting, by the network, a service requested by the terminal, which has received the ESG, to the terminal.

14. The method as claimed in claim 13, wherein the key for decoding the ESG is transmitted through a dedicated channel of the interactive network.

15. A network apparatus for providing an encrypted Electronic Service Guide (ESG) to a terminal in a mobile Digital Video Broadcasting-Handheld (DVB-H) Convergence of Broadcast and Mobile Services (CBMS) system, the network apparatus comprising:
a SA unit for collecting contents from sources and related metadata in order to provide applications for a specific service;
an ESG provider for generating the ESG for a broadcasting service from the metadata collected by the SA unit; and
a mobility management/control module for managing roaming of the terminal into a neighboring network.
wherein, when the terminal requests the ESG the mobility management/control module provides the terminal with a key for decoding the ESC which has been encrypted, and the encrypted ESG through an interactive network.

16. The network apparatus as claimed in claim 15, wherein the mobility management/control module performs one roaming procedure of a user roaming procedure of providing a service provided by the neighboring network to the terminal, and a service roaming procedure of providing a service desired by the terminal from the neighboring network to the terminal through the interactive network, according to a selection of the terminal.

17. The network apparatus as claimed in claim 15, wherein the mobility management/control module transmits the key for decoding the ESG through a dedicated channel of the interactive network.

18. A terminal for receiving an encrypted Electronic Service Guide (ESG) from a network in a mobile Digital Video Broadcasting-Handheld (DVB-H)
Convergence of Broadcast and Mobile Services (CBMS) system, the terminal comprising:
a broadcast receiver for receiving a broadcasting service or signal from a broadcast network:
an interactive adaptor for receiving an interactive service or signal from an interactive network; and
a mobility management/control module for managing roaming into a neighboring network,
wherein the mobility management/control module receives the encrypted ESG of the broadcasting service provided by the network and a key for encoding the encrypted ESG through the interactive adaptor, and requests the network to provide a desired service by making reference to an ESG which has been decoded by the key.

19. The terminal as claimed in claim 18, wherein, when it is determined, based on the decoded ESG, that the neighboring network provides the service desired by the terminal, the mobility management/control module performs a service roaming procedure of receiving the desired service from the neighboring network through the interactive network; and
when it is determined that the neighboring network does not provide the desired service, the mobility management/control module performs a user roaming procedure of receiving a service provided by the neighboring network.

20. The terminal as claimed in claim 18, wherein the interactive adaptor receives the key for decoding the ESG through a dedicated channel of the interactive network.
